(19) United States
(12) Patent Application Publication
(10) Pub. No.: US 2008/0020299 A1
(43) Pub. Date: Jan. 24, 2008

(54) Mask and manufacturing method of microlens using thereof

(75) Inventor: Jun Seok Lee, Goyang-si (KR)

Correspondence Address: THE LAW OFFICES OF ANDREW D. FORTNEY, PH.D., P.C., 401 W FALLBROOK AVE STE 204, FRESNO, CA, 93711-5835, US

(73) Assignee: Dongbu HiTek Co., Ltd.

(21) Appl. No.: 11/880,237

(22) Filed: Jul. 20, 2007

(30) Foreign Application Priority Data
Jul. 21, 2006 (KR) 10-2006-0068696

(51) Int. Cl. G03C 1/00; G03C 5/00

(52) U.S. Cl. 430/5; 430/321

(57) ABSTRACT

The present invention relates to a mask and a method of manufacturing a microlens using the mask, which condenses external light in a CMOS image sensor so that the microlens irradiated by means of a photodiode can have an excellent radius of curvature. With the present invention, the phase shift mask for forming the microlens in the CMOS image sensor is formed by stacking at least two phase shifting layers having different transmissivity from each other so that the microlens can have even size when forming the microlens using the phase shift mask and the microlens can have even curvature regardless of the location of the mask pattern array.

The present application claims priority under 35 U.S.C. 119 and 35 U.S.C. 365 to Korean Patent Application No. 10-2006-0068696 (filed on Jul. 21, 2006), which is hereby incorporated by reference in its entirety.

### BACKGROUND

1. Technical Field

The present invention relates to a mask and a method of manufacturing a microlens using the mask, allowing a microlens of a CMOS image sensor to have excellent radius of curvature.

2. Description of the Related Art

Generally, an image sensor is a semiconductor device converting an optic image into an electrical signal. It may be classified as a charge coupled device (CCD) image sensor or a CMOS image sensor.

The charge coupled device (CCD) has a structure where the respective MOS capacitors are adjacently disposed to each other and a scheme where a charge carrier is stored in an optional MOS capacitor and then is transmitted to a MOS capacitor subsequent thereto. The charged coupled device has a disadvantage of a relatively complicated fabrication process due to a relatively complicated driving scheme, large power consumption, and many photolithographic processing steps. Also, it is difficult to integrate a control circuit, a signal processing circuit, an analog/digital converter, etc. onto a charge coupled device chip so that it has a disadvantage of difficulty in miniaturization of a product.

Recently, a CMOS sensor has been spotlighted as a next generation image sensor for overcoming the disadvantages of the charge coupled device.

The CMOS image sensor is a device that has a number of MOS transistors related or equivalent to the number of unit pixels on a semiconductor substrate using CMOS processing techniques that has a control circuit and a signal processing circuit, etc. as a neighboring circuit to a photodiode to adopt a switching manner sequentially detecting outputs of the respective unit pixels by means of the MOS transistors. In other words, the CMOS image sensor includes a photodiode and MOS transistors in a unit pixel to sequentially detect electrical signals of the respective unit pixels in a switching manner, implementing an image.

The CMOS image sensor is made using a CMOS fabrication technique so that it has an advantage of a simple fabrication process, small power consumption, fewer photolithographic processing steps, etc. Also, a control circuit, a signal processing circuit, an analog/digital converting circuit, etc. can be integrated onto a CMOS image sensor chip so that it has an advantage of easiness in miniaturization of a product. Therefore, at the present time, the CMOS image sensor has been widely used in various applied fields such as a digital still cameras, digital video cameras, cell phone cameras, etc.

FIG. 1 is a plan view of a mask pattern for manufacturing a microlens of the related art, and FIGS. 2a and 2b are cross-sectional views taken along lines A-A′ and B-B′ of the microlens manufactured by the mask pattern of FIG. 1.

As shown in FIGS. 1, 2a and 2b, a mask 50 of the related art is provided with a mask pattern 51 for forming a microlens 40 on a semiconductor substrate. However, in the related art, although the size of the mask pattern 51 is even, a microlens pattern 41a on the semiconductor substrate formed by an outermost mask pattern of the mask 50 is smaller than the standard of an original microlens pattern 41b so that it has a problem that the microlens 40 has uneven radius of curvature.

As shown in FIG. 2a, microlens patterns 41a and 41b in a concavo-convex shape can be formed by applying a resist substance sensitive to transparency and thermal flow on a planarization layer 16 and using a binary mask (BIM). At this time, as the microlens pattern 41a becomes closer to a pattern array edge of the mask, its size becomes smaller due to the optical proximity effect according to pattern density.

And, as shown in FIG. 2b, the planarization layer 16 provided with the microlens pattern in a concavo-convex shape is subjected to a high-temperature bake process, wherein the high-temperature bake process is made at high temperature of 180° C. or more for a predetermined time. In the process, the microlens pattern 40b in a concavo-convex shape is formed in a embossing shape with smooth curvature due to the characteristics of thermal flow.

However, the microlens pattern 40 in an embossing shape has the problems that the radius of curvature of the microlens pattern 40a formed in the high-temperature bake process can be uneven between locations where the pattern density is dense and where the pattern density is sparse, and the microlens formed by the edge mask pattern is smaller than the standard of the original microlens, and its radius of curvature may become uneven between locations corresponding to the edge mask pattern and other locations.

Also, when forming the microlens pattern on the semiconductor substrate, the mask is generally designed using a BIM. However, when using the BIM, the boundary between a lens unit and a non-lens unit is not optically and clearly differentiated so that a pattern defect may occur when forming the microlens pattern on a substrate having a step difference. In other words, in the case of the binary mask, a desired pattern is formed with chrome on a quartz substrate. Therefore, light is transmitted through the portion where chrome is removed, and the remaining chrome serves as a light shielding film. However, if contrast between light-shielding and light-transmitting portions of the mask is degraded due to light diffraction and interference phenomena, a pattern may not be formed as desired on a final wafer.

### SUMMARY OF THE INVENTION

It is an object of the present invention to provide a mask and a method of manufacturing a microlens (which condenses external light in a CMOS image sensor) using the mask so that the microlens can have an excellent radius of curvature.

In order to accomplish the above object, according to the present invention, there is provided a mask comprising: a mask pattern area; and a mask pattern thereon comprising a first phase shifting layer and a second phase shifting layer thereon, the first phase shifting layer having a first transmissivity and the second phase shifting layer having a second transmissivity different from the first transmissivity.

Also, in order to accomplish the above object, according to the present invention, there is provided a method of manufacturing a microlens using a mask comprising the steps of: forming a transparent resist layer on a semiconductor substrate; disposing a mask over the transparent resist layer and irradiating light through the mask onto the transparent resist layer, the mask having a mask pattern on a mask pattern area, the mask pattern comprising a first phase shifting layer and a second phase shifting layer on the first phase shifting layer, the first phase shifting layer having a first transmissivity and the second phase shifting layer having a second transmissivity different from the first transmissivity; and patterning the transparent resist layer to form a microlens pattern.

In addition, the present invention provides a method of making a mask, comprising the steps of forming a first phase shifting layer having a first transmissivity on a mask substrate; and forming a second phase shifting layer having a second transmissivity different from the first transmissivity on the first phase shifting layer.

### BRIEF DESCRIPTION OF THE DRAWINGS

FIG. 1 is a plan view of a mask pattern for manufacturing a microlens of the related art.

FIGS. 2a and 2b are cross-sectional views taken along lines A-A′ and B-B′ of the microlens pattern and microlens manufactured using the mask pattern of FIG. 1.

FIG. 3 is a cross-sectional view of a portion of a CMOS image sensor according to the present invention.

FIG. 4a is a cross-sectional view of the phase shift mask according to the present invention.

FIG. 4b is a cross-sectional view of microlenses formed using the mask of FIG. 4a.

FIGS. 5a to 5c are cross-sectional views sequentially showing an exemplary manufacturing process of the phase shift mask according to the present invention.

FIG. 6 is a plan view of an exemplary mask pattern for manufacturing microlenses according to the present invention.

FIG. 7 is a cross-sectional view taken along lines C-C′ and D-D′ of microlenses manufactured by means of the mask pattern of FIG. 6.

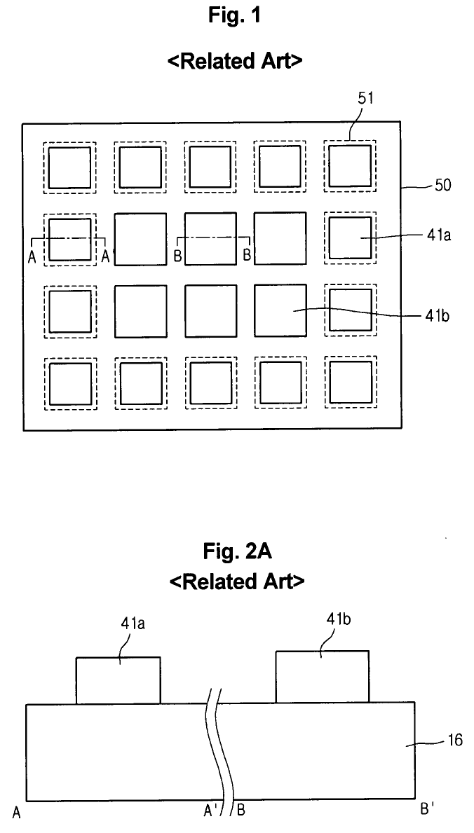

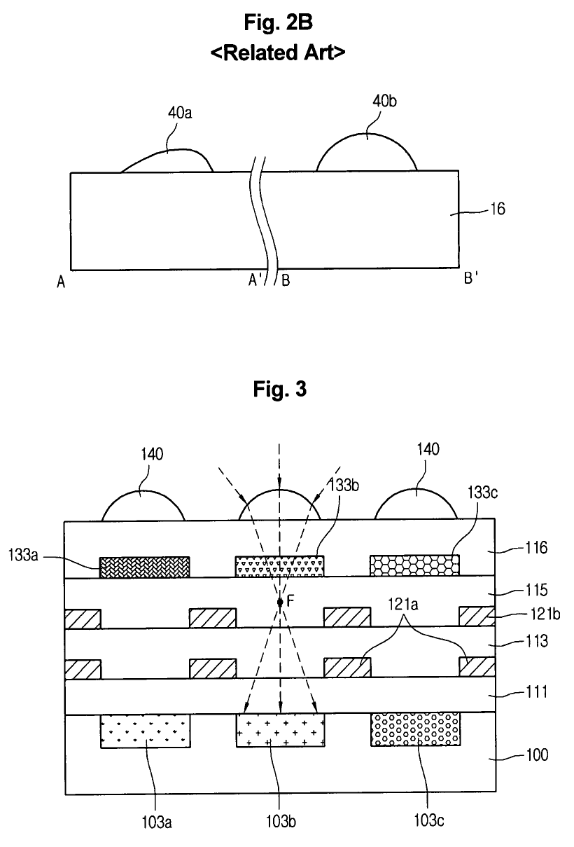

### DETAILED DESCRIPTION OF THE EMBODIMENTS

Hereinafter, a mask for manufacturing a plurality of microlenses according to the present invention will be described in detail with reference to the accompanying drawings.

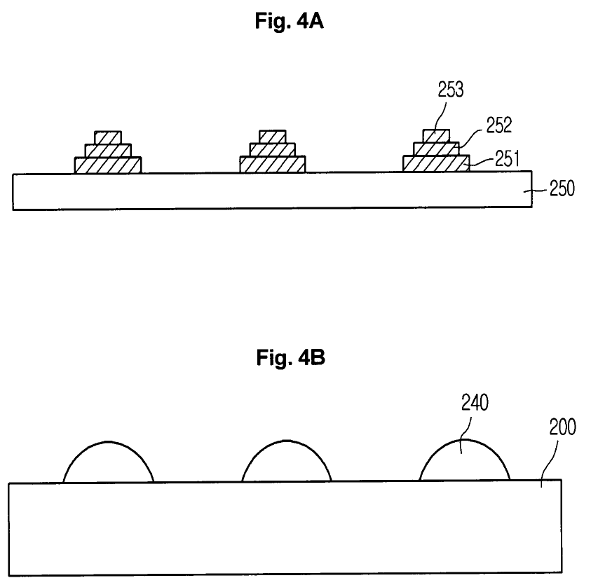

FIG. 3 is a cross-section of a portion of a CMOS image sensor according to the present invention.

Referring to FIG. 3, photodiode areas 103a, 103b, and 103c and a transistor area are prepared on a semiconductor substrate 100 such as a P+ type silicon substrate. Although not specifically shown, a N− type diffusion area may be formed in the photodiode area(s), and source/drain terminals and a gate electrode for a transistor may be formed in the transistor area. A first (interlayer) dielectric layer 111, a light shielding or first metallization pattern 121a, a second (interlayer) dielectric layer 113, a light shielding or second metallization pattern 121b, and a third (interlayer) dielectric layer 115, etc. are continuously stacked over the semiconductor substrate 100, and red, green, and blue color filters 133a, 133b, and 133c are formed on the third interlayer dielectric layer 115 in locations corresponding to the photodiode areas 103a, 103b, and 103c.

And, a planarization layer 116 is formed on the color filters 133a, 133b, and 133c. Thereafter, a plurality of microlenses 140 are formed on the planarization layer 116 so that each microlens 140 is located on a perpendicular line to the photodiode area 103a, 103b, or 103c.

Meanwhile, although not shown, the transistor comprises a light charge transmitter transmitting light charge generated from the photodiode, and a light color sensitivity calculator sensing an amount of light (e.g., red, green, or blue) received by the photodiode. The CMOS image sensor applies (multiple) back bias voltages to the rear surface of the semiconductor so that it varies the width of the depletion area of the photodiode and senses the red, green, or blue light received on the photodiode.

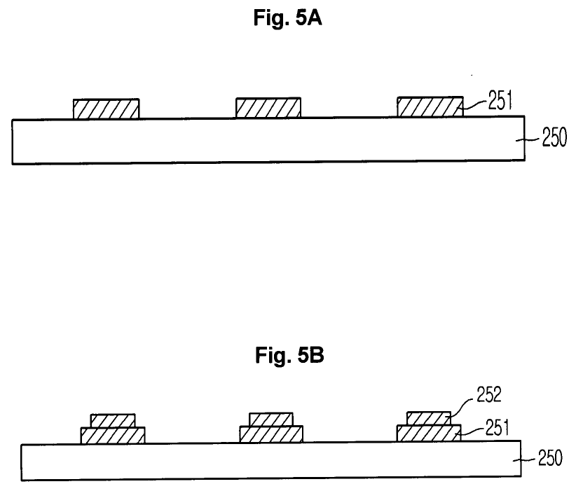

FIG. 4a is a cross-sectional view of an exemplary phase shift mask according to the present invention, and FIG. 4b is a cross-sectional view of exemplary microlenses formed using the mask of FIG. 4a.

As shown in FIG. 4a, the phase shift mask according to the present invention forms a desired pattern by stacking transflective phase shifting material on a transparent quartz substrate 250 in a plurality of (e.g., three) layers. The mask, which in one embodiment comprises a transflective phase shifting material, is formed by sequentially stacking a first phase shifting layer 251, a second phase shifting layer 252, and a third phase shifting layer 253, wherein it is preferable that the second phase shifting layer 252 has a smaller line width than the first phase shifting layer 251 of a, and the center of the second phase shifting layer 252 conforms or aligns to that of the first phase shifting layer 251. Also, it is preferable that the third phase shifting layer 253 has a smaller line width than the second phase shifting layer 252, and the center of the third phase shifting layer 253 conforms or aligns to that of the first and second phase shifting layers 251 and 252.

Each of the first to third phase shifting layers 251, 252, and 253 can have different sizes or dimensions (e.g., thickness and/or width), etc., according to the desired curvature of the microlens 240, and they are made of transflective phase shifting material (e.g., chrome or other material conventionally used to make transmission-reducing or light-blocking regions on a mask). It is preferable that the first to third phase shifting layers 251, 252, and 253 have (or define regions on the mask having) different light transmissivities and phase transition rates from each other.

If the microlens 240 is patterned on a substrate 200 using the mask of FIG. 4a and is subject to a low-temperature bake process, the microlens 240 having even curvature regardless of the location in a mask lens array can be formed, as shown in FIG. 4b.

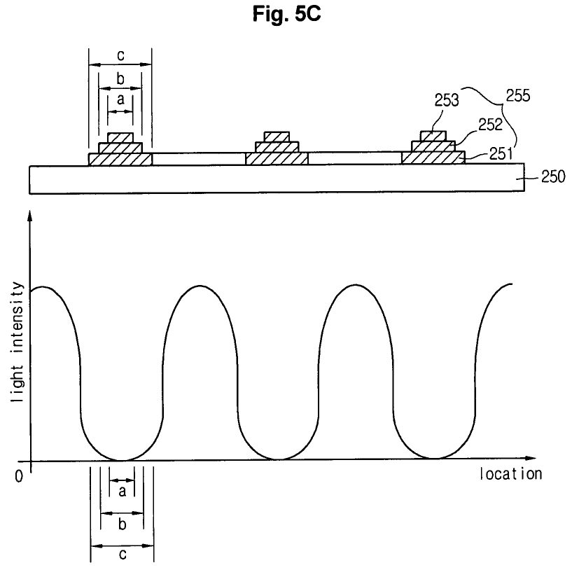

FIGS. 5a to 5c are cross-sectional views showing the fabrication process of an exemplary phase shift mask according to the present invention.

As shown in FIG. 5a, a first transflective phase shifting material is patterned on a desired location on a transparent quartz substrate 250 in a lithography process to form a first phase shifting layer 251 on the quartz substrate. For example, the first phase shifting layer 251 may have a light transmissivity of about 6% and a phase transition rate of 180°.

As shown in FIG. 5b, a second transflective phase shifting material is applied on the quartz substrate 250 provided with the first phase shifting layer 251 and patterned in a lithography process to form a second phase shifting layer 252 on the first phase shifting layer 251, wherein the second phase shifting layer 252 has a smaller line width as compared to the first phase shifting layer 251. For example, the second phase shifting layer 252 may have a light transmissivity of about 4% and a phase transition rate of 225°.

As shown in FIG. 5c, a third transflective phase shifting material is applied on the quartz substrate 250 provide with the first and second phase shifting layers 251 and 252 and patterned in a lithography process to form a third phase shifting layer 253 on the second phase shifting layer 252, wherein the third phase shifting layer 253 has a smaller line width as compared to the second phase shifting layer 252. For example, the third phase shifting layer 253 may have a light transmissivity of about 2% and a phase transition rate of 270°.

Therefore, if the line width of the first phase shifting layer 251 is referred to as “c”, the line width of the second phase shifting layer 252 is referred to as “b”, and the line width of the third phase shifting layer 253 is referred to as “a”, the region of the mask corresponding to the line width “a” of the third phase shifting layer 253 (where the first, second and third phase shifting layers 251-253 are stacked) has the lowest light transmissivity. That region also has a phase shift that approaches 180°, as shown in FIG. 5C. The light transmissivity increases in order in the regions where only the first and second phase shifting layers 251 and 252 are stacked (e.g., corresponding to line width “b”) and the region where only the first phase shifting layer 251 is formed (e.g., corresponding to line width “a”). Among the mask patterns, the light transmissivity in the area where the first to third phase shifting layers 251, 252, and 253 are continuously stacked in a vertical direction from the substrate is the lowest.

The first to third phase shifting layers 251, 252, and 253 (which are at least part of a mask pattern 255 of the phase shift mask according to the present invention) may have different transmissivities from each other. Independently, the transmissivity of a given phase shifting layer may be selected from values in the range of from 2% to 10%. The mask pattern 255 has a structure where at least two (or more) phase shifting layers are stacked, as a minimum condition.

FIG. 5c shows a graph showing the relation of light intensity according to locations of an exemplary phase shift mask according to the present invention. Herein, if the mask pattern 255 where the first to third phase shifting layers 251, 252, and 253 are stacked is irradiated, the light passing therethrough has a phase difference of 180° (or thereabout) from the light passing through a central portion of a light-transmitting region of quartz substrate 250 (e.g., passing through only the quartz substrate 250), and the offset interference of light occurs in the place where the transparent quartz substrate 250 semitransmitting film material (e.g., the region where only the first phase shifting layer 251 is formed, corresponding to line width “a”; optionally, a different material, not shown) to improve contrast, finally making it possible to obtain a desired microlens pattern on the semiconductor substrate regardless of the location of the microlens on the wafer or the corresponding phase shifting layer(s) in the mask pattern.

At this time, the present invention has advantages that the boundary between the lens unit and the non-lens unit is clearly differentiated, and a critical dimension (CD) of the microlens pattern is improved. Also, although the ends of the microlens pattern 240 become adjacent to each other, the present invention can evenly maintain the slope and/or curvature of the microlens. And, the present invention modifies the line width and/or thickness of the first to third phase shifting layers 251, 252, and 253, making it possible to form microlenses having a desired radius of curvature and increasing the receiving rate of the photodiode.

The mask pattern 255 of the phase shift mask is described by showing a structure where the first to third phase shifting layers 251, 252, and 253 are stacked in one embodiment of the present invention, but is not limited thereto. Therefore, the mask pattern 255 can be formed by stacking at least two (or more) phase shifting layers.

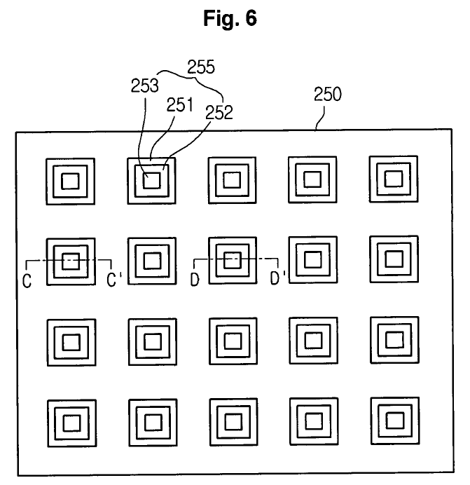

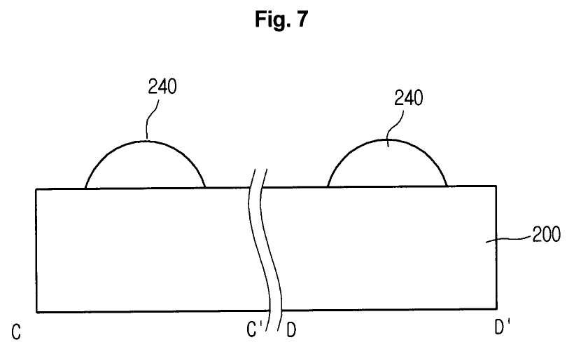

FIG. 6 is a plan view of an exemplary mask pattern for manufacturing microlenses according to the present invention, and FIG. 7 is a cross-sectional view taken along lines corresponding to C-C′ and D-D′ in FIG. 6 of the microlenses manufactured using the mask pattern of FIG. 6.

As shown in FIGS. 6 and 7, an exemplary phase shift mask according to the present invention is provided with a mask pattern 255 formed on a quartz substrate 250 in order to form a plurality of microlenses 240 on a substrate 200.

As shown in FIG. 6, the mask pattern 255 is formed by sequentially stacking a first phase shifting layer 251, a second phase shifting layer 252, and a third phase shifting layer 253 on a quartz substrate 250, wherein it is preferable that the second phase shifting layer 252 has a smaller line width than the first phase shifting layer 251, and the center of the second phase shifting layer 252 conforms to or aligns with that of the first phase shifting layer 251. It is also preferable that the third phase shifting layer 253 has a smaller line width than the second phase shifting layer 252, and the center of the third phase shifting layer 253 conforms to or aligns with that of the first and second phase shifting layers 251 and 252.

Each of the first to third phase shifting layers 251, 252, and 253 can have a different size or dimension (e.g., thickness and/or width, etc.), according to the desired curvature of the microlens 240. The phase shifting layers 251, 252, and 253 may also comprise or be made of transflective phase shifting material.

It is preferable that the first to third phase shifting layers 251, 252, and 253 have different light transmissivities and phase transition rates from each other.

If the microlens 240 having an even size is patterned on a substrate 200 using the phase shift mask of FIG. 6 and is subject to a low-temperature below 110° C. bake process, microlenses 240 having even and/or uniform curvature regardless of the location of a mask lens array can be formed, as shown in FIG. 7.

When forming the microlens pattern using the phase shift mask according to the present invention, a defect that the microlens curvature in or near the edge of the mask becomes uneven can be prevented (e.g., by means of the high-temperature bake process).

With the present invention, the phase shift mask for forming the microlens in the CMOS image sensor is formed by stacking at least two or more phase shifting layers having different transmissivities from each other so that the microlens can have an even or more uniform size when forming the microlens using the phase shift mask, and/or the microlens can have an even or more uniform curvature regardless of the location on the mask pattern array. Also, when forming the microlens pattern using the phase shift mask according to the present invention, a defect that the microlens curvature on the edge of the mask becomes uneven is prevented (e.g., by means of a high-temperature bake process), and the microlens has even curvature (e.g., by means of a low-temperature bake process), regardless of the density of the microlens pattern, making it possible to improve manufacturing yield.

Also, present invention can clearly differentiate the boundary between the lens unit and the non-lens unit on the semiconductor substrate and can improve the CD of the microlens pattern. Also, although the end of the microlens pattern becomes close to the end of the microlens pattern adjacent thereto, the present invention can maintain the slope and/or curvature of the microlens, making it possible to improve resolution of the microlens.

Also, the present invention may modify one or more line widths and/or thicknesses of the phase shifting layer of the mask, making it possible to variously form microlenses having a desired radius of curvature and possibly increase the receiving rate of light at the photodiode.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A mask comprising:
a transparent mask defined with a mask pattern area; and
a mask pattern on the mask pattern area, comprising a first phase shifting layer and a second phase shifting layer on the first phase shifting layer, the first phase shifting layer having a first transmissivity and the second phase shifting layer having a second transmissivity different from the first transmissivity.

2. The mask according to claim 1, further comprising a third phase shifting layer.

3. The mask according to claim 2, wherein the first phase shifting layer has a larger line width than the second phase shifting layer, and the second phase shifting layer has a larger than line width than the third phase shifting layer.

4. The mask according to claim 1, wherein the transmissivity of the first and second phase shifting layers is independently from 2% to 10%.

5. The mask according to claim 1, wherein the first and second phase shifting layers independently have a phase transition rate from 180° to 270°.

6. The mask according to claim 1, wherein the mask pattern has different light transmissivity depending on location on the mask.

7. The mask according to claim 2, wherein the first, second and third phase shifting layers have respective center lines that conform to each other.

8. The mask according to claim 1, wherein the first and second phase shifting layers each have a different thickness.

9. The mask according to claim 3, wherein the third phase shifting layer is on the second phase shifting layer.

10. The mask according to claim 9, wherein the mask has a lowest light transmissivity in a location of the third phase shifting layer.

11. A method of making a microlens comprising the steps of:
forming a transparent resist layer on a semiconductor substrate;
disposing a mask over the transparent resist layer and irradiating light through the mask onto the transparent resist layer, the mask having a mask pattern on a mask pattern area, the mask pattern comprising a first phase shifting layer and a second phase shifting layer on the first phase shifting layer, the first phase shifting layer having a first transmissivity and the second phase shifting layer having a second transmissivity different from the first transmissivity; and
patterning the transparent resist layer to form a microlens pattern.

12. The method according to claim 11, further comprising the step of baking the semiconductor substrate and the microlens pattern at temperature of 80° to 100° C., after the step of forming the microlens pattern.

13. The method according to claim 11, further comprising a third phase shifting layer on the second phase shifting layer, wherein the first phase shifting layer has a larger line width than the second phase shifting layer, and the second phase shifting layer has a larger line width than the third phase shifting layer.

14. The method according to claim 11, wherein the mask pattern has different light transmissivity depending on a location on the mask.

15. The method according to claim 13, wherein the first, second and third phase shifting layers have respective center lines that conform to each other.

16. The method according to claim 11, wherein the first and second phase shifting layers each have a different thickness.

17. The method according to claim 13, wherein the mask has a lowest light transmissivity in a location of the third phase shifting layer.

18. A method of making a mask, comprising the steps of:
forming a first phase shifting layer having a first transmissivity on a mask substrate; and
forming a second phase shifting layer having a second transmissivity different from the first transmissivity on the first phase shifting layer.

19. The method according to claim 18, further comprising a third phase shifting layer on the second phase shifting layer.

20. The method according to claim 19, wherein the first phase shifting layer has a larger line width than the second phase shifting layer, and the second phase shifting layer has a larger line width than the third phase shifting layer.
